(19) United States
(12) Patent Application Publication
(10) Pub. No.: US 2025/0268430 A1
(43) Pub. Date: Aug. 28, 2025

(54) BATH TOWEL, BATH TOWEL SYSTEM, ABSORBENT TOWEL SYSTEM, PROCESS, AND METHODS OF USE

(71) Applicants: Candra Milligan, Lees Summit, MO (US); Tanner Milligan, Lees Summit, MO (US)

(72) Inventors: Candra Milligan, Lees Summit, MO (US); Tanner Milligan, Lees Summit, MO (US)

(21) Appl. No.: 18/590,398

(22) Filed: Feb. 28, 2024

(51) Int. Cl. A47K 10/02; A47D 13/02

(52) U.S. Cl. CPC A47K 10/02; A47D 13/02

(57) ABSTRACT

A bath towel, a bath towel system, an absorbent drying system, a process, and methods of use are presented. More specifically, and without limitation, the present disclosure relates to a drying system which enables a first user to conveniently hold and dry a second user such as a child, infant, toddler, animal, pet, or the like. More specifically, and without limitation, the present disclosure relates to an absorbent material which prevents the first user from becoming wet or damp, while enabling the first user to handle objects, and the like, which are wet; and dry wet objects or second users. Thus, an easy to use, comfortable, drying apparatus which prevents the adult user or first user from becoming wet during use.

### CROSS-REFERENCE TO RELATED APPLICATIONS

The present application claims priority to the U.S. Provisional Patent Application No. 63/449,089 which was filed on Mar. 1, 2023, which is hereby incorporated by reference herein in its entirety, including any figures, tables, or drawings.

### FIELD OF THE INVENTION

This disclosure relates to a bath towel, a bath towel system, an absorbent drying system, a process, and methods of use. More specifically, and without limitation, the present disclosure relates to a drying system which enables a first user to conveniently hold and dry a second user such as a child, infant, toddler, animal, pet, or the like. More specifically, and without limitation, the present disclosure relates to an absorbent material which prevents the first user from becoming wet or damp, while enabling the first user to handle objects, and the like, which are wet; and dry wet objects or second users.

### BACKGROUND OF THE INVENTION

Towels are well known in the art. Generally, a towel is an absorbent material used for drying wet people, surfaces, cleaning, and the like. In households, several types of towels may be identified, such as bath towels, hand towels, kitchen towels, and more.

One application of bath towels is for cleaning newborns, infants, children, toddlers, or animals. Infants and young children, or pets, are sensitive to temperature so it is important to keep them comfortable during bathing and not let them be out of water and/or wet for too long. In many cases, it is desirable to dry a newborn or pet immediately after bathing. Some newborns, children, or pets may not like being dried. For these reasons, and others, bathing a newborn, young child, or pet can be an undesirable task, especially since the adult or one washing usually gets wet and/or causes their clothes to become wet during the process.

Thus, it is desirable for an easy to use, comfortable, drying apparatus which prevents the adult user or first user from becoming wet during use.

The disclosure herein provides these advantages and others as will become clear from the specification and claims provided.

### SUMMARY OF THE INVENTION

A bath towel, a bath towel system, an absorbent drying system, a process, and methods of use are presented. More specifically, and without limitation, the present disclosure relates to a drying system which enables a first user to conveniently hold and dry a second user such as a child, infant, toddler, animal, pet, or the like. More specifically, and without limitation, the present disclosure relates to an absorbent material which prevents the first user from becoming wet or damp, while enabling the first user to handle objects, and the like, which are wet; and dry wet objects or second users. Thus, an easy to use, comfortable, drying apparatus which prevents the adult user or first user from becoming wet during use.

Thus, it is a primary object of the disclosure to provide a bath towel, a bath towel system, an absorbent drying system, a process, and methods of use that improves upon the state of the art.

Another object of the disclosure is to provide a bath towel, a bath towel system, an absorbent drying system, a process, and methods of use that provides a luxury towel which can be used for newborn and young children in a hands free method for parents.

Yet another object of the disclosure is to provide a bath towel, a bath towel system, an absorbent drying system, a process, and methods of use that provides a luxury towel which can be used for newborn and young children in a hands free method.

Another object of the disclosure is to provide a bath towel, a bath towel system, an absorbent drying system, a process, and methods of use that provides a luxury towel which can be used for newborn and young children.

Yet another object of the disclosure is to provide a bath towel, a bath towel system, an absorbent drying system, a process, and methods of use that keeps a baby or pet warm during the drying process.

Another object of the disclosure is to provide a bath towel, a bath towel system, an absorbent drying system, a process, and methods of use that are oversized.

Yet another object of the disclosure is to provide a bath towel, a bath towel system, an absorbent drying system, a process, and methods of use that keeps the baby or newborn covered during the entire drying process.

Another object of the disclosure is to provide a bath towel, a bath towel system, an absorbent drying system, a process, and methods of use that provides easy slit access in the towel body to ensure that the first user can engage the object securely.

Yet another object of the disclosure is to provide a bath towel, a bath towel system, an

absorbent drying system, a process, and methods of use that can be used to remove a newborn, infant, toddler, or pet from the bathing area.

Another object of the disclosure is to provide a bath towel, a bath towel system, an absorbent drying system, a process, and methods of use that utilizes an easy to use magnetic clasp for engaging the first user.

Yet another object of the disclosure is to provide a bath towel, a bath towel system, an absorbent drying system, a process, and methods of use that provides a hands free experience.

Another object of the disclosure is to provide a bath towel, a bath towel system, an absorbent drying system, a process, and methods of use that provides a magnetic clasp which secures the system around the neck of a user; providing for securement of the apparatus for a hands free experience and/or enabling the hands of the first user to be free for handling of a toddler, baby, pet, or the like-both for removal from a bathing area and drying.

Yet another object of the disclosure is to provide a bath towel, a bath towel system, an absorbent drying system, a process, and methods of use that provides handhole access.

Another object of the disclosure is to provide a bath towel, a bath towel system, an absorbent drying system, a process, and methods of use that provide magnets for clasping around neck.

Yet another object of the disclosure is to provide a bath towel, a bath towel system, an absorbent drying system, a process, and methods of use that provides attachment features for securing to a first user.

Another object of the disclosure is to provide a bath towel, a bath towel system, an absorbent drying system, a process, and methods of use that are oversized.

Yet another object of the disclosure is to provide a bath towel, a bath towel system, an absorbent drying system, a process, and methods of use that includes a plurality of layers.

Another object of the disclosure is to provide a bath towel, a bath towel system, an absorbent drying system, a process, and methods of use that includes a first absorbent layer.

Yet another object of the disclosure is to provide a bath towel, a bath towel system, an absorbent drying system, a process, and methods of use that includes a second water proof layer.

Another object of the disclosure is to provide a bath towel, a bath towel system, an absorbent drying system, a process, and methods of use that includes an insulation layer.

Yet another object of the disclosure is to provide a bath towel, a bath towel system, an absorbent drying system, a process, and methods of use that provides a hood.

Another object of the disclosure is to provide a bath towel, a bath towel system, an absorbent drying system, a process, and methods of use that provides pockets.

Yet another object of the disclosure is to provide a bath towel, a bath towel system, an absorbent drying system, a process, and methods of use that provides storage.

Another object of the disclosure is to provide a bath towel, a bath towel system, an absorbent drying system, a process, and methods of use that are easy to use.

Yet another object of the disclosure is to provide a bath towel, a bath towel system, an absorbent drying system, a process, and methods of use that is warming.

Another object of the disclosure is to provide a bath towel, a bath towel system, an absorbent drying system, a process, and methods of use that are safe to use.

Yet another object of the disclosure is to provide a bath towel, a bath towel system, an absorbent drying system, a process, and methods of use that are hands free.

Another object of the disclosure is to provide a bath towel, a bath towel system, an absorbent drying system, a process, and methods of use that saves time for a user.

Yet another object of the disclosure is to provide a bath towel, a bath towel system, an absorbent drying system, a process, and methods of use that prevent a user from getting wet.

These and other objects, features, or advantages of the present disclosure will become apparent from the specification and claims.

### BRIEF DESCRIPTION OF DRAWINGS

The drawings accompanying and forming part of this specification are included to depict certain aspects of the disclosure.

FIG. 1 is a front, perspective view of the system; the view showing the main body extending a length from a first end to a second end between opposing sides; the view showing a hood extending a length from a first end to a second end; the view showing a plurality of apertures.

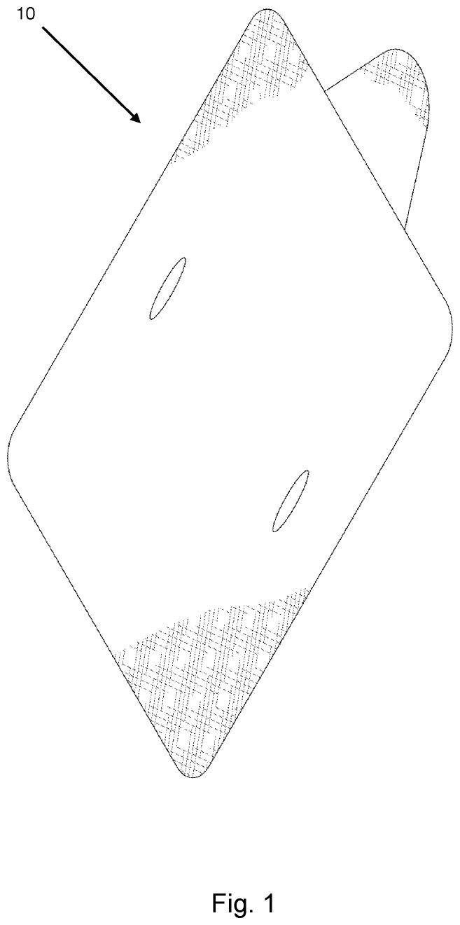

FIG. 2 is a front, perspective view of the system; the view showing the main body extending a length from a first end to a second end between opposing sides; the view showing a hood extending a length from a first end to a second end; the view showing a plurality of apertures.

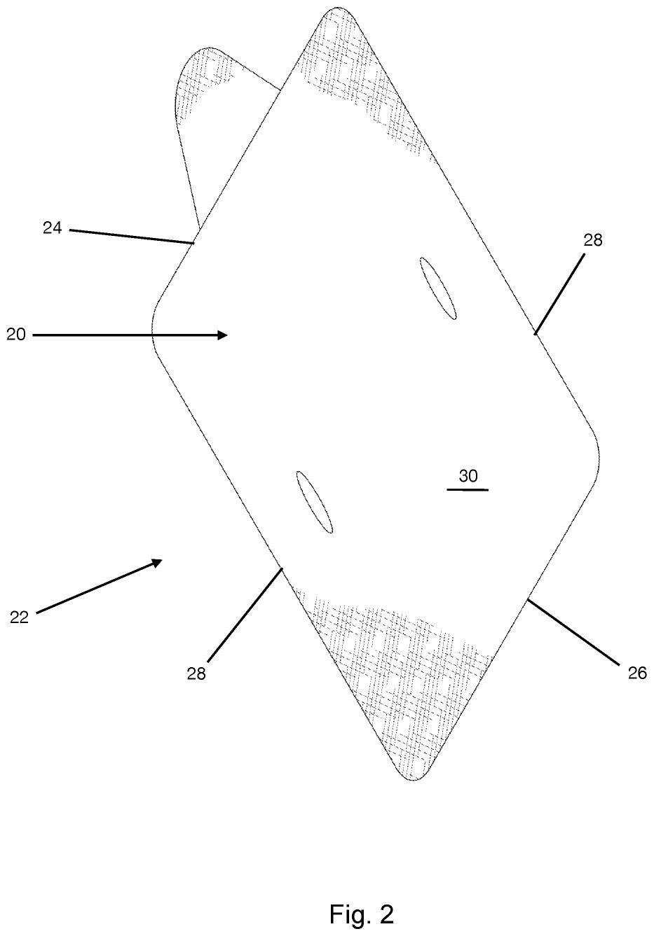

FIG. 3 is a rear, perspective view of the system; the view showing the main body extending a length from a first end to a second end between opposing sides; the view showing a hood extending a length from a first end to a second end; the view showing a plurality of apertures; the view showing a plurality of clasps.

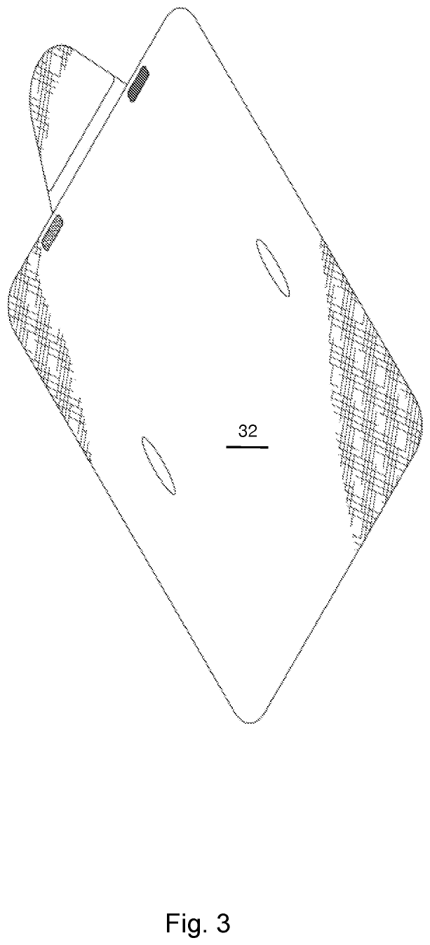

FIG. 4 is a front view of the system; the view showing the main body extending a length from a first end to a second end between opposing sides; the view showing a hood extending a length from a first end to a second end; the view showing a plurality of apertures.

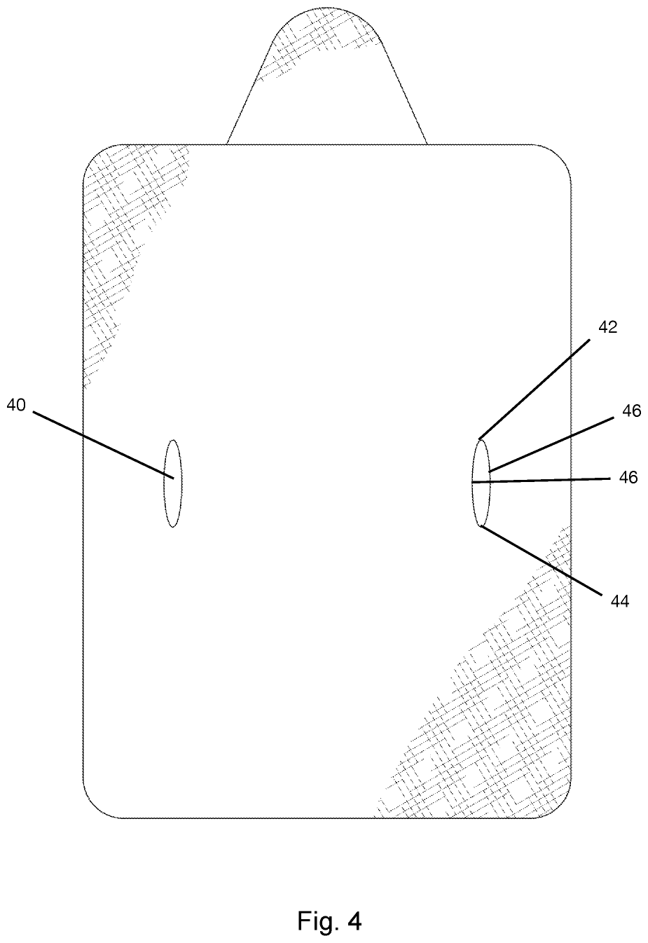

FIG. 5 is a rear view of the system; the view showing the main body extending a length from a first end to a second end between opposing sides; the view showing a hood extending a length from a first end to a second end; the view showing a plurality of apertures; the view showing a plurality of clasps.

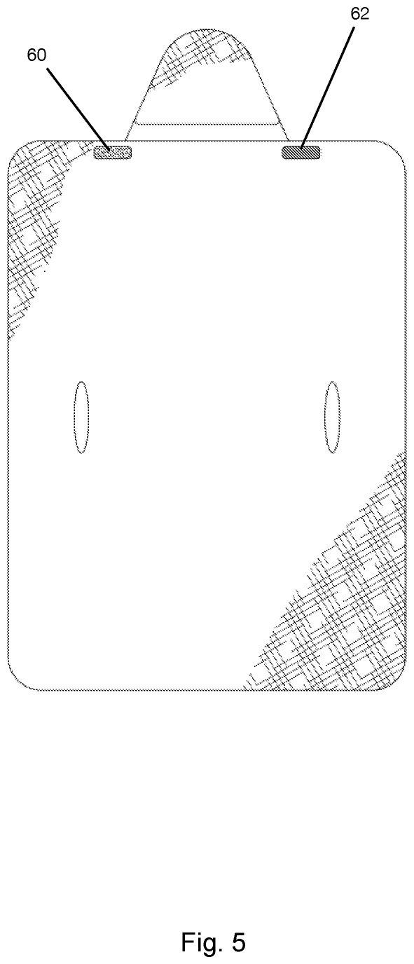

FIG. 6 is a view showing the system; the view showing a first user interacting with the system and a second user; the view showing the second user engaged within the interior of the system.

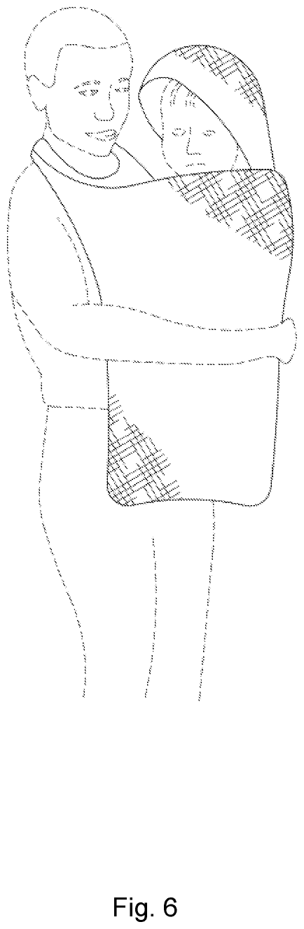

FIG. 7 is a rear view of the system; the view showing the main body extending a length from a first end to a second end between opposing sides; the view showing a hood extending a length from a first end to a second end; the view showing a plurality of apertures; the view showing a plurality of clasps.

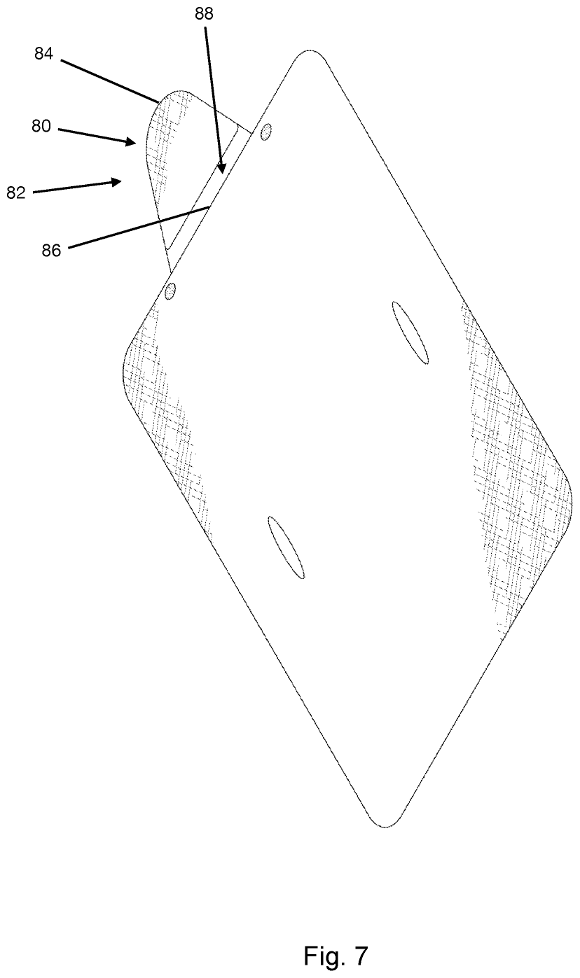

FIG. 8 is a rear view of the system; the view showing the main body extending a length from a first end to a second end between opposing sides; the view showing a hood extending a length from a first end to a second end; the view showing a plurality of apertures; the view showing a plurality of clasps.

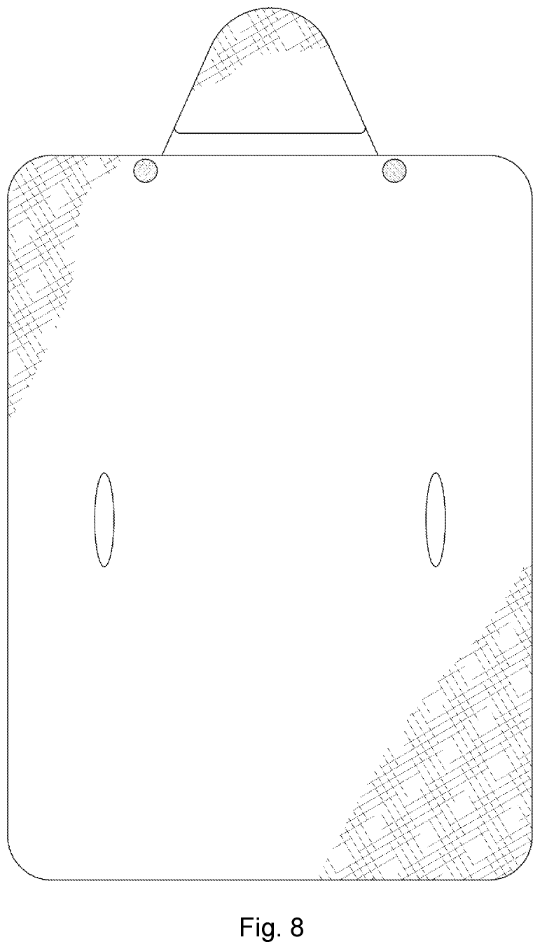

FIG. 9 is a view showing the system; the view showing a first user interacting with the system and a second user; the view showing the second user engaged within the interior of the system.

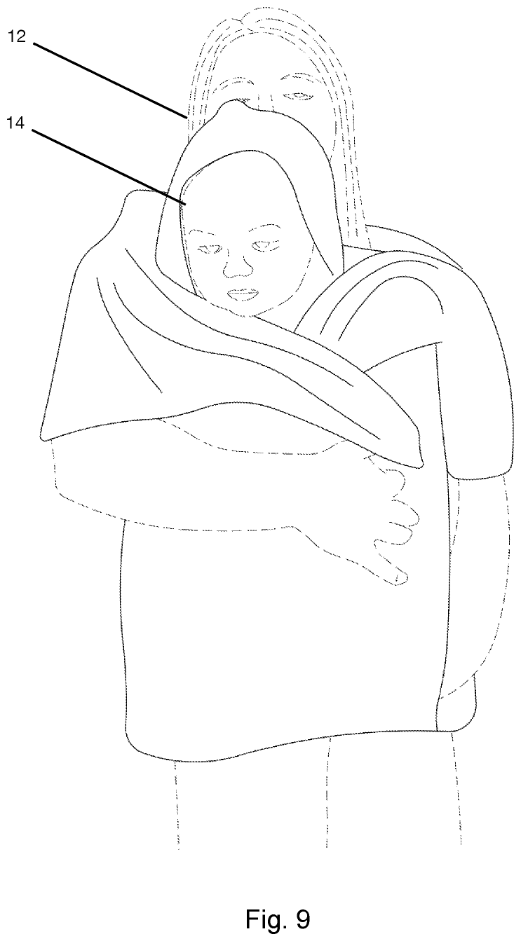

### DESCRIPTION

In the following detailed description, reference is made to the accompanying drawings which form a part hereof, and in which is shown by way of illustration specific embodiments in which the disclosure may be practiced. These embodiments are described in sufficient detail to enable those skilled in the art to practice the disclosure, and it is to be understood that other embodiments may be utilized and that mechanical, procedural, and other changes may be made without departing from the spirit and scope of the disclosure(s). The following detailed description is, therefore, not to be taken in a limiting sense, and the scope of the disclosure(s) is defined only by the appended claims, along with the full scope of equivalents to which such claims are entitled.

As used herein, the terminology such as vertical, horizontal, top, bottom, front, back, end, sides and the like are referenced according to the views, pieces and figures presented. It should be understood, however, that the terms are used only for purposes of description, and are not intended to be used as limitations. Accordingly, orientation of an object or a combination of objects may change without departing from the scope of the disclosure.

Reference throughout this specification to “one embodiment,” “an embodiment,” “one example,” or “an example” means that a particular feature, structure, or characteristic described in connection with the embodiment or example is included in at least one embodiment of the present disclosure. Thus, the appearance of the phrases “in one embodiment,” “in an embodiment,” “one example,” or “an example” in various places throughout this specification are not necessarily all referring to the same embodiment or example. Furthermore, the particular features, structures, databases, or characteristics may be combined in any suitable combinations and/or sub-combinations in one or more embodiments or examples. In addition, it should be appreciated that the figures provided herewith are for explanation purposes to persons ordinarily skilled in the art and that the drawings are not necessarily drawn to scale.

### System

With reference to the figures, a bath towel, a bath towel system, an absorbent drying system, a process, and methods of use 10 are presented. Bath towel system 10 (hereafter referred to as “drying system”, “absorbent system”, “cleaning apparatus”, “cleaning system”, or simply “system”) is formed of any suitable size, shape and design.

In the arrangement shown, as one example, system 10 is configured to provide a barrier and absorbent apparatus such that a first user, such as an adult, parent, pet owner, or the like can handle a newborn, infant, child, pet with an absorbent apparatus and dry the latter without becoming wet. Furthermore, and in this way, a first user can easily do this in a convenient way while keeping the second comfortable and warm.

In the arrangement shown, as one example, the main structure of system 10 also includes a plurality of layers 16, a main body 20, a plurality of access features 40, a plurality of attachment features or clasps 60, and a hood or covering feature 80, among other components, features, and functionality.

### User (or Plurality Thereof)

In the arrangement shown, as one example, system 10 includes a first user 12 and a second user 14. First user 12 and second user 14 may be any user interacting with or utilizing the system 10. This may include any user interacting with, drying, being cleaned by system 10. User is not limited to a single user but may be a plurality of users.

First User: For ease of example, a first user is commonly an adult or parent user who is handling a second user.

Second User: For ease of example, a second user may be a newborn, an infant, a toddler, or other young child, or child, or pet, or object being dried by the first user. A second user need not be living but may be an object such as dishes or the like that a first user wishes to dry or handle.

### Plurality of Layers

In the arrangement shown, as one example, system 10 includes a plurality of layers 16 (also referred to as “absorbent layers”, “barrier layers”, or simply “layers”). Layers 16 are formed of any suitable size, shape, and design, and are configured to provide absorbance, warmth, and a barrier. The plurality of layers 16 may include, but are not limited to, a first layer 17, a second layer 18, a third layer 19, and more layers. The layers 16 may include a first absorbent layer, a second absorbent layer, an insulation layer, a second insulating layer, a first waterproof layer, a second waterproof layer, a softness layer, and more. Other layers as may be desired for various applications are hereby contemplated for use. This may also include a grip layer, a haircatch or pethair catch layer, among other layers.

### Main Body

In the arrangement shown, as one example, system 10 includes a main body 20 (also referred to as “towle”, “material”, or simply “body”). Body 20 is formed of any suitable size, shape, and design, and is configured to provide the barrier, absorption, and the like. Main body 20 extends a length 22 from a first end 24 (or top) to a second end 26 (or bottom) between opposing sides 28. The main body 20 includes an interior surface 30 facing the first user and an exterior surface 32 facing a second user. The main body 20 may include a plurality of layers, and a plurality of access ports 40.

### Plurality of Access Ports

In the arrangement shown, as one example, system 10 includes a plurality of access ports 40 (also referred to as “ports”, “slits”, or simply “access ports”). Access ports 40 are formed of any suitable size, shape, and design, and are configured to provide access for the two arms of a first user so a user can reach through and/or to the opposite side of the main body 20. The access ports each extend a length from a top to a bottom between opposing sides.

Plurality of access ports 40 extend a length between a top 42, a bottom 44, and opposing sides 46.

### Plurality of Clasps

In the arrangement shown, as one example, system 10 includes a plurality of clasps 60 (also referred to as “clasps”, “securement features”, or simply “magnets”). Plurality of clasps 60 may also include a plurality of magnets 62, and are formed of any suitable size, shape, and design, and are configured to secure the main body 20 around the neck of a first user so that the system can be operated hands free. This further protects the user by creating a full barrier between the first user and the second user.

### Absorbent Material

In the arrangement shown, as one example, the main body 20 is formed of an absorbent material. The absorbent material can remove moisture from the head, neck, body, and the like. In the arrangement shown, as one example, main body 20 is formed of an absorbent microfiber material. However, other materials are hereby contemplated for use. Examples of other materials include, but are not limited to absorbent materials, absorbent fabric, cotton, rayon, polyester, bamboo cloth, synthetic materials, a mix of materials, a combination thereof, and the like. Furthermore, various colors and the like are also contemplated for use.

### Hood/Covering

In the arrangement shown, as one example, system 10 may also include a hood or covering 80 (also referred to as “extension”, “hood”, or simply “covering”). Covering 80 is formed of any suitable size, shape, and design, and is configured to cover the head of a second user to provide warmth, drying, and comfort.

Hood covering 80 extends a length 82 from a first end 84 to a second end 86 and is operably attached via an attachment feature 88 to the main body. In the arrangement shown, as one example, the attachment feature 88 is formed of a stitching. In an alternative embodiment, the attachment feature may be a zipper, a plurality of buttons, a plurality of magnets, or the like. In an alternative embodiment the hood can be removed. In another embodiment the hood is a single construction with the main body.

### Absorbent Material

In the arrangement shown, as one example, the main body 20 is formed of an absorbent material. The absorbent material can remove moisture from the head, neck, body, and the like. In the arrangement shown, as one example, main body 20 is formed of an absorbent microfiber material. However, other materials are hereby contemplated for use. Examples of other materials include, but are not limited to absorbent materials, absorbent fabric, cotton, rayon, polyester, bamboo cloth, synthetic materials, a mix of materials, a combination thereof, and the like. Furthermore, various colors and the like are also contemplated for use.

### Additional Features/Alternative Embodiment

In the arrangement shown, as one example, system 10 may also include alternative shapes, sizes, designs, features. In one example, an alternative embodiment may include a pouch feature such that a second user can sit into a pouch located nearer the bottom. In this way a first user can easily wrap up and comfort a second user. Furthermore, in another alternative embodiment, the main body may include a plurality of leg holes or other apertures for access and the like. In yet another alternative embodiment, system 10 may include a plurality of storage pockets which are closeable or remain accessible, or the like. In another embodiment, system 10 may include a plurality of zippers and/or hook and loop for accessing storage pockets, hood removal, neck securement, and the like. These and other alternative embodiments and features are hereby contemplated for use.

In addition to the above identified features, options, controls, and components, system 10 may also include other features and functionalities, among other options, controls, and components.

It will be appreciated by those skilled in the art that other various modifications could be made to the system, process, and method of use without parting from the spirit and scope of this disclosure. All such modifications and changes fall within the scope of the claims and are intended to be covered thereby.

1. A system for engaging and drying, comprising:
a main body;
the main body extending a length from a first end to a second end;
the main body extending the length between opposing sides;
the main body having an interior surface and an exterior surface;
a plurality of access ports;
each of the plurality of access ports having a top and a bottom between opposing sides;
a plurality of clasps;
wherein the plurality of clasps are formed of a plurality of magnets;
wherein the plurality of magnets at each part cause the main body to form shapes, by engaging with one another;
a hood covering;
the hood covering extending a length from a first end to a second end.

2. The system of claim 1, further comprising:
wherein the main body is formed of an absorbent material;
wherein the absorbent material is formed of a microfiber.

3. The system of claim 1, further comprising:
wherein the main body is formed of an absorbent material.

4. The system of claim 1, further comprising:
a first user;
a second user;
wherein the first user engages the second user with the system for drying; wherein the first user engages the second user by wrapping the second user in the main body.

5. The system of claim 1, further comprising:
a first user;
a second user;
wherein the attachment feature is operably connected the hood covering to the main body; wherein the hood covering is operably connected to the main body by engaging and disengaging the second user; wherein engaging is when the hood covering is covering the second user; wherein disengaging is when the hood covering is not covering the second user.

6. The system of claim 1, further comprising:
the hood covering having an attachment feature.

7. The system of claim 1, further comprising:
a first user;
a second user;
wherein the first user engages the second user with the system for drying; wherein the first user engages the second user by wrapping the second user in the main body;
wherein the first user secures the main body to the first user by the plurality of clasps;
wherein engaging the main body to the first user is engaging the clasps behind the neck of the first user so that the main body hangs around the neck of the first user.

8. The system of claim 1, further comprising:
a first user;
a second user;
wherein the first user engages the second user with the system for drying; wherein the first user engages the second user by wrapping the second user in the main body;
wherein the first user secures the main body to the first user by the plurality of clasps;
wherein engaging the main body to the first user is engaging the clasps behind the neck of the first user so that the main body hangs around the neck of the first user;
wherein after the first user connects the clasps behind the neck of the first user the first user engages the second user with the main body serving as a barrier between the first user and the second user; wherein the first user dries the second user.

9. The system of claim 1, further comprising:
a first user;
a second user;
wherein the first user engages the second user with the system for drying; wherein the first user engages the second user by wrapping the second user in the main body;
wherein the first user secures the main body to the first user by the plurality of clasps;
wherein engaging the main body to the first user is engaging the clasps behind the neck of the first user so that the main body hangs around the neck of the first user;
wherein after the first user connects the clasps behind the neck of the first user the first user engages the second user with the main body serving as a barrier between the first user and the second user; wherein the first user dries the second user;
wherein the first user engages the hood covering on the second user.

10. The system of claim 1, further comprising:
a first user;
a second user;
wherein the first user engages the second user with the system for drying; wherein the first user engages the second user by wrapping the second user in the main body;
wherein the first user secures the main body to the first user by the plurality of clasps;
wherein engaging the main body to the first user is engaging the clasps behind the neck of the first user so that the main body hangs around the neck of the first user;
wherein after the first user connects the clasps behind the neck of the first user the first user engages the second user with the main body serving as a barrier between the first user and the second user; wherein the first user dries the second user;
wherein the first user places engages the hood covering on the second user;
wherein the first user engages the second user after the second user is wrapped in the main body through the plurality of access ports.

11. The system of claim 1, further comprising:
a first user;
a second user;
wherein the first user engages the second user with the system for drying; wherein the first user engages the second user by wrapping the second user in the main body;
wherein the first user secures the main body to the first user by the plurality of clasps;
wherein engaging the main body to the first user is engaging the clasps behind the neck of the first user so that the main body hangs around the neck of the first user;
wherein after the first user connects the clasps behind the neck of the first user the first user engages the second user with the main body serving as a barrier between the first user and the second user; wherein the first user dries the second user;
wherein the first user places engages the hood covering on the second user;
wherein the first user engages the second user after the second user is wrapped in the main body through the plurality of access ports;
wherein the attachment feature is operably connected the hood covering to the main body; wherein the hood covering is operably connected to the main body by engaging and disengaging the second user; wherein engaging is when the hood covering is covering the second user; wherein disengaging is when the hood covering is not covering the second user.

12. The system of claim 1, further comprising:
wherein the hood is operably connected by a plurality of buttons.

13. The system of claim 1, further comprising:
wherein the hood covering is operably connected by magnets forming magnetic engagement.

14. The system of claim 1, further comprising:
wherein the hood covering is operably connected by stitching.

15. The system of claim 1, further comprising:
wherein the second user is an infant.

16. The system of claim 1, further comprising:
wherein the hood covering is formed of an absorbent material;
wherein the attachment feature is operably connected the hood covering to the main body; wherein the hood covering is operably connected to the main body by engaging and disengaging the second user; wherein engaging is when the hood covering is covering; wherein disengaging is when the hood covering is not covering.

17. System of drying an infant after bathing, comprising:
a first user;
a second user;
a main body;
the main body extending a length from a first end to a second end;
the main body extending the length between opposing sides;
the main body having an interior surface and an exterior surface;
wherein the main body is formed of an absorbent material;
a plurality of access ports;
each of the plurality of access ports having a top and a bottom between opposing sides;
a plurality of clasps;
wherein the plurality of clasps are formed of a plurality of magnets;
wherein the plurality of magnets at each part cause the main body to form shapes, by engaging with one another;
a hood covering;
the hood covering extending a length from a first end to a second end;
wherein the hood covering is formed of an absorbent material;
the hood covering having an attachment feature;
wherein the attachment feature is operably connected the hood covering to the main body; wherein the hood covering is operably connected to the main body by engaging and disengaging the second user; wherein engaging is when the hood covering is covering the second user; wherein disengaging is when the hood covering is not covering the second user;
wherein the first user engages the second user with the system for drying; wherein the first user engages the second user by wrapping the second user in the main body;
wherein the first user secures the main body to the first user by the plurality of clasps;
wherein engaging the main body to the first user is engaging the clasps behind the neck of the first user so that the main body hangs around the neck of the first user;
wherein after the first user connects the clasps behind the neck of the first user the first user engages the second user with the main body serving as a barrier between the first user and the second user; wherein the first user dries the second user;
wherein the first user places engages the hood covering on the second user;
wherein the first user engages the second user after the second user is wrapped in the main body through the plurality of access ports.

18. The system of claim 17, further comprising:
wherein the second user is a pet.

19. The system of claim 17, further comprising:
wherein the second user is an infant.

20. A method of drying a second user without getting wet, comprising the steps:
picking up a system; the system having a main body; the main body extending a length from a first end to a second end; the main body extending the length between opposing sides; the main body having an interior surface and an exterior surface; wherein the main body is formed of an absorbent material;
the system having a plurality of access ports; each of the plurality of access ports having a top and a bottom between opposing sides;
the system having a plurality of clasps; wherein the plurality of clasps are formed of a plurality of magnets; wherein the plurality of magnets at each part cause the main body to form shapes, by engaging with one another;
the system having a hood covering; the hood covering extending a length from a first end to a second end; wherein the hood covering is formed of an absorbent material; the hood covering having an attachment feature;
wrapping the system around a neck of a first user;
clasping the plurality of clasps in place to provide hands-free operation for the first user;
engaging the second user by wrapping the second user inside the main body;
covering the second user with the hood covering;
drying the second user by wiping down the second user.
